(19) United States
(12) Patent Application Publication
(10) Pub. No.: US 2007/0014649 A1
(43) Pub. Date: Jan. 18, 2007

(54) Fixation device and method of fixation

(76) Inventor: Dugal Simon Stewart James, Bendigo, Victoria (AU)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 10/554,182

(22) PCT Filed: Apr. 23, 2004
(86) PCT No.: PCT/AU04/00530

§ 371 Date: Jul. 17, 2006

(30) Foreign Application Priority Data
Apr. 23, 2003 (AU) 2003901971

(51) Int. Cl. F16B 39/00

(52) U.S. Cl. 411/81

(57) ABSTRACT

A fixation device for fixing a first member in a position relative to a second member includes a shaft having a head and a longitudinal axis, a first screw portion rotatable about the axis, and a second screw portion rotatable about the axis independently of the first screw portion. Each of the first and second screw portions has an external screw thread in a first thread direction and is configured to engage a bore formed in the first and second members. The fixation device is particularly useful in joining broken bones.

### FIELD OF THE INVENTION

This invention relates to a method of fixing a first member in a position relative to a second member and a fixation device for doing the same. It relates particularly but not exclusively to a fixation device and method for its use and a tool for using the fixation device.

### BACKGROUND TO THE INVENTION

Bones, including joints of the body are susceptible to injury including dislocation, fracture and damage as a result of trauma, disease and degenerative change. There are many ways of reducing a fracture, employing open or closed reduction such as casting, external fixation, wiring and plating. Casting and other forms of closed reduction involves aligning the broken or dislocated bone manually and setting it, usually by applying a cast. This is beneficial because it avoids the trauma of surgery and is relatively inexpensive. However, it is only suitable for relatively simple fractures and requires immobilisation of the bone which can cause stiffness and impede rehabilitation.

External fixation involves the insertion of pins into bone fragments and connecting the pins using a bar or frame which sits outside the fracture site. Although this facilitates reduction of more complex fractures, it can cause irritation of the skin and soft tissue around the pins causing infection or scarring which may compromise outcomes. Open reduction and internal fixation requires extensive exposure to allow for the approximation of bone fragments and the introduction of fixation devices.

In each case, the procedure must be performed with a high degree of accuracy to ensure that the bone is not damaged further and that it is correctly realigned with respect to its anatomic and biomechanical axes.

### SUMMARY OF THE INVENTION

According to a first aspect of the present invention, there is provided a fixation device for fixing a first member in a position relative to a second member, the fixation device including:

(a) a shaft having a head and a longitudinal axis;

(b) a first screw portion rotatable about the axis; and

(c) a second screw portion rotatable about the axis independently of the first screw portion;

the first and second screw portions each having an external screw thread in a first thread direction and configured to engage a bore formed in the first and second members.

According to one embodiment of the fixation device:

(a) the first screw portion is a collar screw;

(b) the shaft includes an externally threaded portion; and

(c) the second screw portion includes a corresponding internal thread;

wherein assembly of the fixation device includes passing the shaft through the centre of the collar screw prior to threadedly engaging the second screw portion on the shaft. This arrangement may further include a lock nut having an internal thread corresponding with the shaft thread, and configured to maintain the position of the second screw portion on the shaft.

According to another embodiment of the fixation device, the first screw portion is a collar screw with an opening along its length for receiving a length of the shaft.

According to another embodiment of the fixation device the head includes an external screw thread in a second thread direction and the first screw portion includes a corresponding internal thread to facilitate assembly of the fixation device by screwing the first screw portion over the head. In this arrangement, the external screw thread of the head may have a leading end and a trailing end such that the trailing end terminates in a flat end so as to substantially preclude engagement with a threaded member. The internal thread of the first screw portion configured to engage the external thread of the head preferably has a leading end and a trailing end such that the trailing end terminates in a flat end so as to substantially preclude engagement with a threaded member.

In some embodiments of the invention, the shaft may be flexible. In other embodiments, the shaft is rigid.

According to another aspect of the invention, there is provided a method of fixing a first member in a position relative to a second member, the method including the steps of:

(a) assembling a fixation device;

(b) forming a bore in the first and second members;

(c) introducing the fixation device into the bore, the fixation device having:

(i) a shaft having head and a longitudinal axis;
(ii) a first screw portion rotatable about the axis; and
(iii) a second screw portion rotatable about the axis independently of the first screw portion;
   the first and second screw portions each having an external screw thread adapted to engage the bore in the first and second members;
      (d) operating the fixation device in such a way that one of the first or second screw portions rotates relative to the threaded bore thereby positioning the first member relative to the second member; and
      (e) locking the fixation device in position.

In one embodiment of the inventive method, the step of assembling the fixation device includes passing the shaft through the centre of the first screw prior to threadedly engaging the second screw portion on the shaft.

In another embodiment, the first screw portion is a collar screw with an opening along its length for receiving a length of the shaft, and the step of assembling the fixation device includes passing the shaft through the lengthwise opening of the first screw.

In another embodiment the head includes an external screw thread in a second thread direction and the first screw portion includes a corresponding internal thread, and the step of assembling the fixation device involves screwing the first screw portion over the head.

### BRIEF DESCRIPTION OF THE DRAWINGS

The invention will now be described in greater detail with reference to the embodiments illustrated in the accompanying drawings. It is to be understood that the particularity of the accompanying drawings does not supersede the generality of the preceding description of the invention.

FIG. 1a illustrates in cross section, a fixation device being inserted into a threaded bore in accordance with an embodiment of the invention.

FIG. 1b shows the sectional view of FIG. 1a after operation of the fixation device to position the first member relative to the second member.

FIG. 2a illustrates in cross section, a fixation device being inserted into a threaded bore in accordance with another embodiment of the invention where the depth of the second member is small.

FIG. 2b shows the sectional view of FIG. 2a after operation of the fixation device to position the first member relative to the second member.

FIG. 2c shows a sectional view of a further embodiment of the invention after operation of the fixation device for the purpose of holding the two members separated by a predetermined interval.

FIG. 3 illustrates in cross section, a fixation device according to an embodiment of the invention.

FIG. 4a illustrates in cross section, a tool for positioning a fixation device in accordance with an embodiment of the invention.

FIG. 4b shows the sectional view of FIG. 4a with the locking mechanism activated.

FIG. 5a illustrates rigid shaft suitable for use according to an embodiment of the invention.

FIG. 5b illustrates a flexible shaft suitable for use according to another embodiment of the invention.

FIG. 6 illustrates a component of an alternative embodiment of the fixation device showing the second screw portion integral with the shaft.

FIG. 7a illustrates in cross section, an alternative embodiment of a first screw portion having a slot.

FIG. 7b shows an end view of the first screw portion illustrated in FIG. 7a.

FIG. 8a illustrates in cross section a variation of the component illustrated in FIG. 6, showing in particular, a flexible shaft.

FIG. 8b illustrates an end view of the component of FIG. 8a.

FIG. 9 illustrates a component of a further embodiment of the fixation device, showing the second screw portion integral with the shaft, with an external thread on the head portion.

FIG. 10a illustrates in cross section, a further embodiment of the first screw portion which an internal thread corresponding to the external thread on the head portion of FIG. 9.

FIG. 10b shows an end view of the first screw portion illustrated in FIG. 10a.

FIG. 11 illustrates in cross section a variation of the component illustrated in FIG. 9.

FIG. 12a illustrates in cross section, a variation of the first screw portion of FIG. 10a.

FIG. 12b shows an end view of the first screw portion illustrated in FIG. 12a.

FIG. 13a illustrates in cross section, an alternative lock screw for use with the first screw portion of FIGS. 12a and 12b.

FIG. 13b shows an end view of the lock screw illustrated in FIG. 13a.

### DETAILED DESCRIPTION

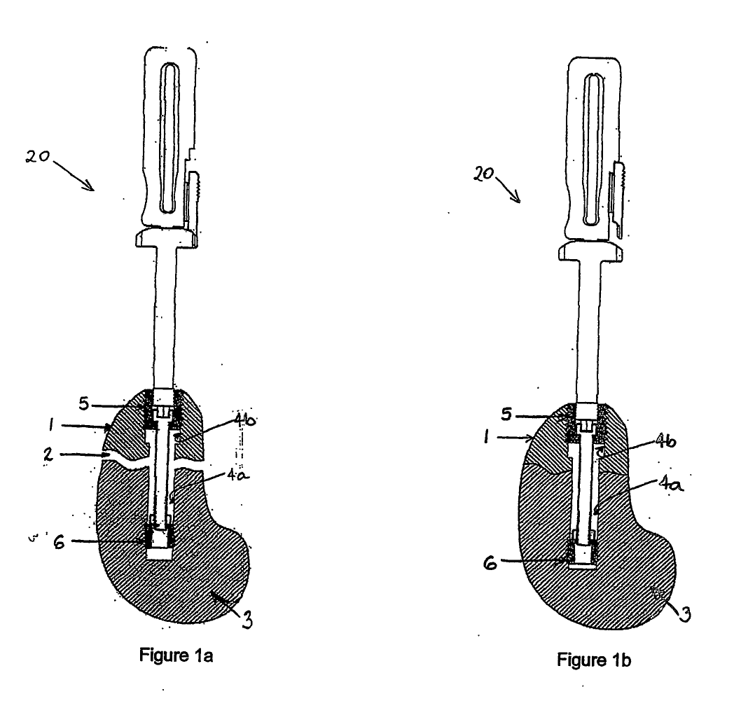

Referring firstly to FIGS. 1a and 1b, a preferred embodiment of the invention is illustrated. A guide wire (not shown) is drilled through first member 1, henceforth referred to first bone section 1, across fracture site 2 and into second member 3, henceforth referred to as second bone section 3. A first bore 4a is formed using a cannulated drill (not shown) to drill through first bone section 1, across fracture site 2 and into second bone section 3.

It is preferred that first bore 4a stops short of penetrating the far end of second bone section 3. A second larger diameter cannulated bit is used to drill through first bore 4a stopping just short of fracture site 2 thus forming a second bore 4b having a larger diameter. Bore 4a may be tapped with a screw thread suitable for engaging first screw portion 5. Similarly, second bore 4b may be tapped with a screw thread suitable for engaging second screw portion 6. For simplicity, combined bores 4a and 4b will hereinafter be referred to as bore 4. Fixation device 10 is then introduced into bore 4.

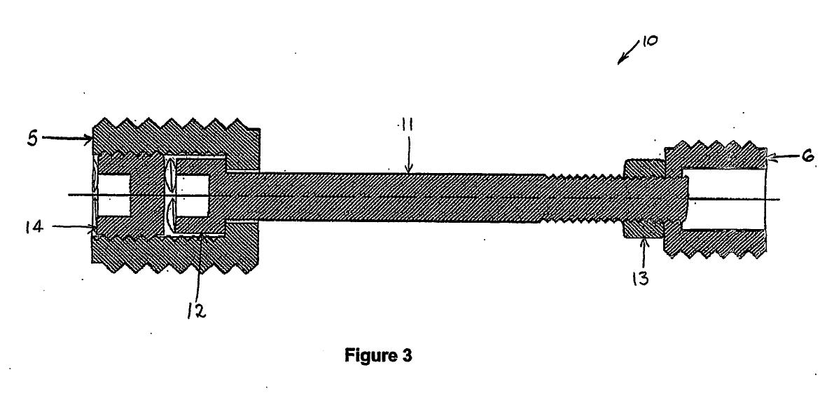

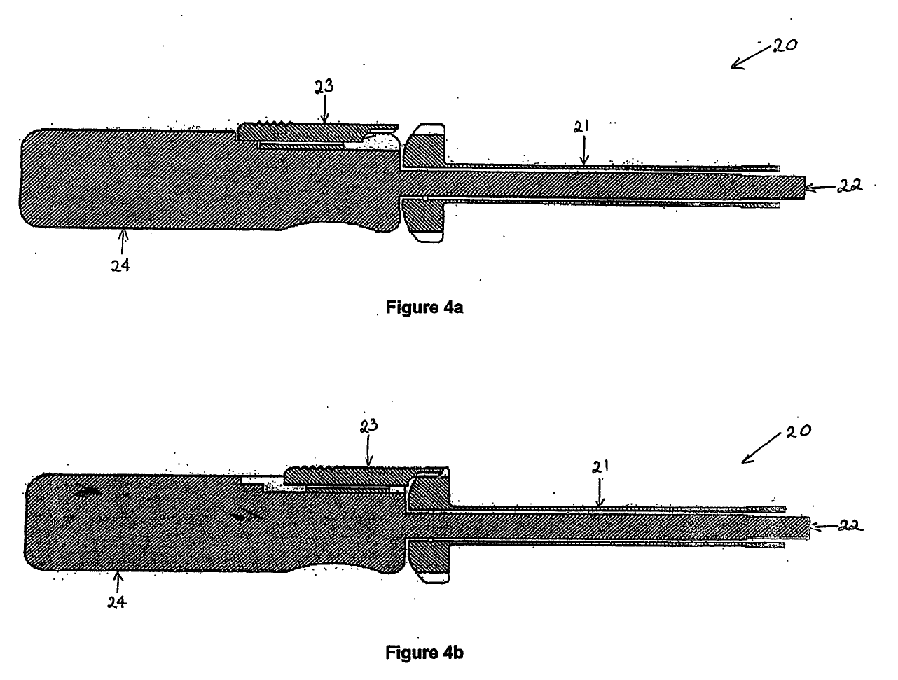

One embodiment of fixation device 10 is illustrated in FIG. 3. It has a shaft 11, first and second screw portions 5,6 and lock nut 13. The fixation device is assembled by passing shaft 11 through first screw portion 5 which is in the form of a larger diameter collar screw with an external thread. Shaft 11 is provided with a left-hand screw thread onto which lock nut 13 is threaded. Second screw portion 6 in the form of a smaller diameter collar screw with an internal screw thread configured to engage the left hand shaft thread. This may be assisted by use of a device such as a hex-head key to engage head 12 of fixation device 10 and hold the shaft still whilst assembling the fixation device. The hex-head key may be provided in the form of tool 20 illustrated in FIG. 4.

Preferably, the overall length of bore 4 is determined so that a fixation device 10 with a suitable length can be selected. Selection of a suitable fixation device may also require consideration of the diameter of the bore in the first and/or second bone sections 1,3. In the embodiment illustrated in FIG. 3, the effective length of the fixation device may be adjusted before inserting the fixation device into the bore, by locating the lock nut 13 and second screw portion 6 at varying positions along the shaft 11. The adjustment permissible is therefore limited by the length of the threaded portion of the shaft.

Shaft 11 has a longitudinal axis about which first screw portion 5 is freely rotatable. Second screw portion 6 is also rotatable about the axis of shaft 11 along the left hand screw thread. Since second screw portion 6 is threaded onto shaft 11 in one direction, rotation of screw portion 6 in the other direction will also rotate shaft 11. It follows that rotation of the shaft will also effect rotation of the second screw portion. However, first screw portion 5 is not threaded onto shaft 11 and therefore rotates freely about the shaft, independently of second screw portion 6.

As can be seen in FIG. 3, first and second screw portions 5,6 each have an external screw thread which is adapted to engage bore 4 in the first and second bone sections 1,3. The pitch of the external screw thread on first screw portion 5 is equal to the pitch of the external screw thread on second screw portion 6. This enables, both screw portions to undergo the same amount of linear translation for each degree of rotation of the fixation device, regardless of screw portion diameter.

Fixation device 10 is introduced into bore 4 over a guide wire (not shown) which aids in maintaining alignment of the bore 4 in first and second bone sections 1,3. Introduction of fixation device 10 may be aided by use of a specially designed tool such as that which is illustrated in FIG. 4.

Referring now to FIG. 4, tool 20 has a first engaging portion 21, a second engaging portion 22 and a locking mechanism 23 as well as a handle 24. First engaging portion 21 is provided in the form of an outer shaft for engaging part of first screw portion 5. Second engaging portion 22 is provided in the form of an inner shaft for engaging part of second screw portion 6 and is operable independently of first engaging portion 21. Locking mechanism 23 can be used to lock movement of first engaging portion 21 relative to second engaging portion 22. For simplicity, first engaging portion 21 will henceforth be referred to as outer shaft 21 and second engaging portion 22 will hence forth be referred to as inner shaft 22.

Preferably, tool 20 is cannulated with a two stage hex-head design. That is, outer and inner shafts 21,22 have a hexagonal cross-section so that inner shaft 22 engages a corresponding hex-head recess in head 12 and outer shaft 21 engages with a hex-head inner aperture provided in first screw portion 5. It is to be understood that other suitable tool-head designs may be employed. Security screw heads are some existing designs which may be suitable.

With locking mechanism 23 activated, movement of inner shaft 22 relative to outer shaft 21 is fixed. Therefore, rotation of handle 24 will facilitate rotation of outer and inner shafts 21,22 together. Accordingly, first and second screw portions 5,6 will rotate together. This enables assembled fixation device 10 to advance into bore 4 with second screw portion advancing through first bone section 1, across fracture site 2 and into a portion of bore 4 formed in second bone section 3. In one embodiment, fixation device 10 is advanced until it reaches the end of bore 4. Since the pitch of the external threads on first and second screw portions 5,6 are equal there is no relative movement of first bone section 1 relative to second bone section 3 during introduction of fixation device 10. The pitch of screw thread on first and second screw portions 5,6 may be selected based on several factors such as the length of the bore and the softness of the bone being positioned. For example, a more coarse thread may be desirable when the screw portion is being screwed into softer bone.

Once fixation device 10 has been introduced into bore 4, that is, it is located in situ, locking mechanism 23 on tool 20 is released so that outer shaft 21 rotates independently of inner shaft 22. Holding outer shaft 21 still, inner shaft 22 engages head 12 and is rotated clockwise. This causes second screw portion 6 to advance into second bone section 3 having the effect of drawing it toward first bone section 1 (since first screw portion 5 is not moving in the first bone section) thereby closing fracture site 2. This is illustrated in FIG. 1b. When the desired relative positioning of the bone sections has been achieved, tool 20 is removed and fixation device 10 is locked into position.

To achieve further closure of the fracture site, tool 20 may be used to engage first screw portion 5 independently of shaft 11. First screw portion 5 may then be rotated counter-clockwise to draw the first screw portion outward of the bore drawing head 12 and therefore shaft 11 and second screw portion 6 with it, closing the gap between first and second bone sections 1,3. This is described in further detail below, in the context of a variation on the above method.

Preferably fixation device 10 is locked into position using a cannulated lock screw 14 which is introduced over the guide wire and screwed inside an internal diameter of first screw portion 5. This may be achieved using a hex-head tool. Preferably, cannulated lock screw 14 is provided with a hex-head socket with the same dimension as the hex-head socket in head 12. Therefore, inner shaft 22 of tool 20 is also suitable to fasten lock screw 14 and lock fixation device 10 into position. Once lock screw 14 has been advanced into first screw portion 5 so that it no longer projects beyond first screw portion 5, outer shaft 21 of tool 20 may be used to engage and hold first screw portion 5 still whilst lock screw 14 is advanced further (if necessary) into the first screw portion. Advancement of lock screw 14 should cease when it is tightened against head 12. Once lock screw 14 is suitably positioned, the guide wires are removed and the procedure is concluded.

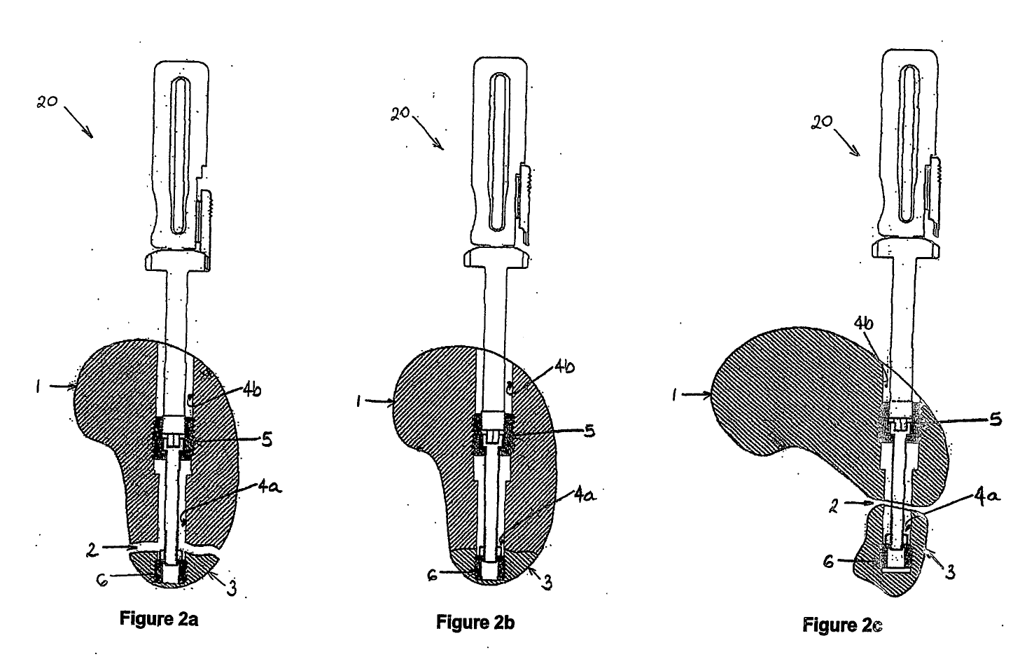

A variation of the above-described method is provided and may be suitable where the depth of second bone section 3 is small and movement of second screw portion 6 within the second bone section 3 should be minimised. Such an embodiment is illustrated in FIGS. 2a and 2b. Bore 4b is drilled stopping just short of the far cortex of second bone section 3. Fixation device 10 is selected with a shaft length which is less than the total overall length of bore 4. Fixation device 10 is introduced into bore 4 over the guide wire so that second screw portion 5 is only just past fracture site 2 in second bone section 3. Using tool 2 with inner shaft 22 held still, outer shaft 21 is rotated counter clockwise causing first screw portion 5 to retract in the portion of bore 4 located in first bone section 1. Since the location of second screw portion 6 is fixed in second bone section 3, this has the effect of drawing first bone section 1 toward second bone section 3, thereby closing fracture site 2.

When the fracture site 2 is closed, locking mechanism 23 is activated and outer and inner shafts 21,22 are rotated together advancing fixation device 10 further into bore 4. Locking mechanism 23 can then be released and the tool used again to rotate outer shaft 21 in an anti-clockwise direction, retracting first screw portion 5. This procedure with outer and inner shafts 21,22 coupled and uncoupled is repeated until first and second bone sections 1,3 are positioned as required.

In another embodiment, peripheral guide wires are introduced in series with the central guide wire prior to drilling and tapping the bore in the first and second members and inserting the fixation device. This assists in controlling potential torque reactions that may develop between the first and second members and other bone fragments particularly when the invention is used in a surgical environment.

It is to be understood that use of the inventive method and apparatus should not be limited to closing of fracture sites. FIG. 2c shows a further embodiment where first and second bone sections 1,3 have been positioned using fixation device 10 without completely closing fracture site 2.

It is to be understood that the methods exemplified herein describe only some of the ways in which the invention may be performed. As an alternative, the first and second bore portions 4a and 4b may have the same diameter, eliminating the need to use 2 cannulated drill bits to form the bore 4. Accordingly, first and second screw portions 5,6 can also share the same diameter.

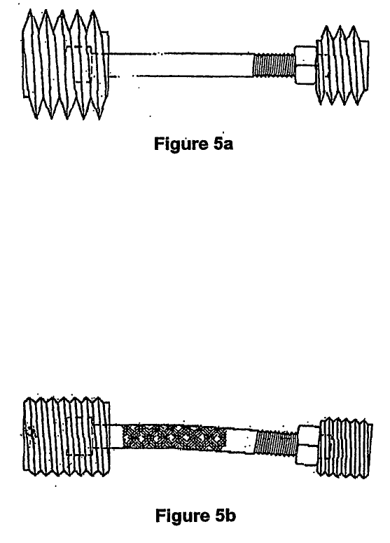

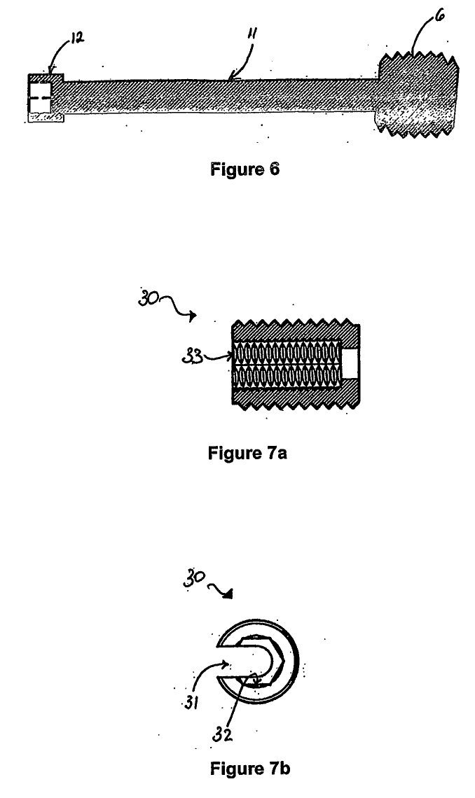

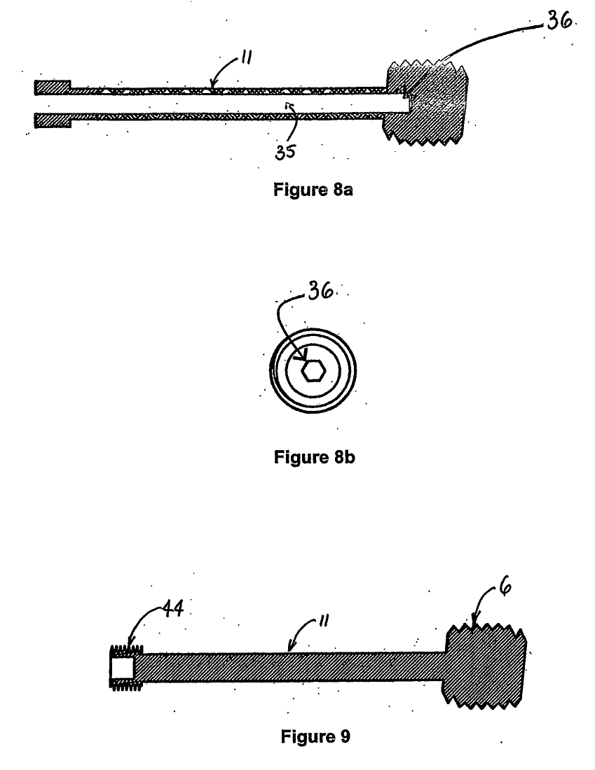

As a further alternative, second screw portion may be welded, glued or otherwise attached to shaft 10 or may be integral with the shaft itself as illustrated in FIG. 6. Clearly this eliminates the need to assemble lock nut 13 and second screw portion 6 on shaft 13. However this does not permit shortening of the length of the fixation device. It is to be understood that using a screw thread to fasten second screw portion 6 to shaft 10 (and a lock nut 13 to retain the position of the second screw portion on the shaft) facilitates adjustment of the overall length of fixation device 10 and may therefore be favourable as it provides modularity, potentially reducing the range of sizes in which the fixation device may need to be manufactured. This modularity also allows each fixation device to be sized just prior to use, on a case by case basis. Although it may be preferred that shaft 10 is rigid as illustrated in the embodiment of FIG. 5a, it may also be flexible as illustrated in FIGS. 5b and 8a.

Referring now to FIGS. 7a and 7b, there is shown a sectional view and end view of an alternative embodiment of the first screw portion, indicated by reference numeral 30. Notably, first screw portion 30 has an elongate opening 31 extending along the length of screw portion 30 and having a width which is sufficient for receiving shaft 11. This allows the fixation device to be assembled by slotting the first screw portion 31 over the shaft rather than by inserting the end of the shaft into the hollow centre of the first screw portion and sliding the first screw portion along the shaft as is necessary for the embodiment illustrated in FIG. 3. Clearly this is advantageous because it eliminates the need to remove the lock screw 13 and second screw portion 6 from the shaft, should a first portion with a different diameter be required. First screw portion 30 also facilitates assembly of the fixation device where second screw portion 6 is integral with shaft 11 as is the case in FIG. 6.

First screw portion 30 also provides a socket 32 for engaging a tool having hex head, such as outer shaft 21, to rotate first screw portion 30 within the bore 4. An internal screw thread 33 configured to receive lock screw 14 is also provided. Preferably internal screw thread 33 is a right handed screw thread.

FIGS. 8a and 8b illustrate a variation of the shaft illustrated in FIG. 6 where the shaft is flexible. In this embodiment, shaft 11 includes a hollow 35 into which an elongate portion of a tool may be inserted. The tool engages second screw portion 6 at engaging region 36 to rotate and advance second screw portion 6 into second bone section 3. For a hex-head shaped tool, engaging region 36 may be provided in the form of a hex-shaped socket as illustrated in FIG. 8b.

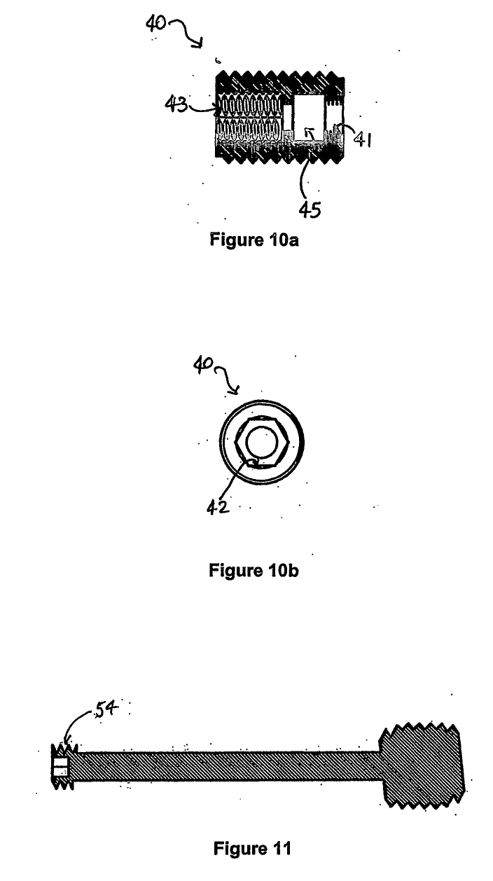

FIGS. 9 and 10a and 10b illustrate components of a further embodiment of the fixation device. First screw portion shown at generally at 40 includes an internally threaded portion 41 providing a left hand screw thread. Shaft 11 has a head portion which includes an external left hand thread 44 corresponding with internal thread portion 41. This allows the fixation device to be assembled by screwing first screw portion 40 over threaded head 44 as an alternative to the assembly method used for the embodiments illustrated in FIGS. 3 and 7a and 7b. Notably, internally threaded portion 41 terminates just inside first screw portion 40. Cavity 45 has no screw thread and allows the head of the shaft to rotate freely therein.

Preferably, the trailing end of the external screw thread 44 on the head ends abruptly in a flat edge rather than in a bevel. This prevents thread 44 from re-engaging with the corresponding internal screw thread 41 of first screw portion 40 and becoming removed therefrom. Similarly, it is desirable to terminate trailing end of internal screw thread 41 of the first screw portion in a flat edge (i.e. with no bevel) to further preclude re-engagement of screw threads 41 and 44 and removal of the head from the first screw portion.

First screw portion 40 also provides a socket 42 for engaging a tool having hex head, such as outer shaft 21, to rotate first screw portion 40 within the bore 4. An internal screw thread 43 configured to receive a lock screw is also provided. Preferably internal screw thread 43 is a right hand screw thread. It is also desirable that the innermost end of internal screw thread 43 also terminates in a flat end, without a bevel to further prevent engagement between the external thread 44 of the head and internal thread 43 of the first screw portion 40. The fact that external thread 44 and internal thread 43 are in opposite directions further prevents the head from engaging the internal thread 43 and working its way out of first screw portion 40. This is advantageous when the fixation device is used as a distraction device, as well as a fracture compression device.

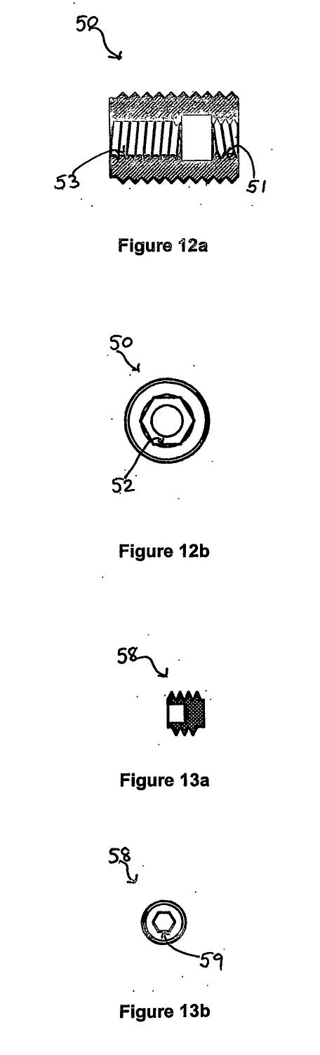

FIGS. 11, 12a, 12b, 13a and 13b illustrate further variations of the components illustrated in FIGS. 9, 10a and 10b. Internal thread 51 of the first portion is a left hand thread configured to engage with corresponding external thread 54 of the head. First screw portion 50 also includes engaging region 52 for engaging a tool to rotate the first screw portion within the first bone section. A lock screw 58 illustrated in FIGS. 13a and 13b, has a right hand thread corresponding with internal thread 53 of the first screw portion 50 and an engaging portion 59 configured to engage a tool, preferably having a hex-head as illustrated in the cross section of FIG. 13b. Lock screw 58 is screwed into the first screw portion along internal thread 53 and will eventually be in abutment with head 12 of shaft 11.

Advantageously, independent rotation of first and second screw portions facilitates multi-stage positioning of first and second bone sections 1,3 and therefore multi-stage closure or positioning of bone sections 1,3 around fracture site 2. The position of first bone section 1 relative to second bone section 3 can be changed by rotating the first and/or second screw portions 5,6 without advancing the entire fixation device further into the bore or changing the overall length of the fixation device. A further advantage provided by the present invention is that the fixation device remains entirely within the confine of the bore. Therefore, it is ideal for use in intraarticular fixation. Moreover, when the fixation device is cannulated and used in conjunction with a guide wire, the invention is highly suited to the closed management of fractures by percutaneous techniques.

A primary application for the present invention is in the field of orthopaedic surgery, as a means of fixation between two bones, one fractured bone or a bone and plate or other such device. There are many different areas in the body and different areas of surgery in which the inventive method and apparatus may be useful. However, it is to be understood that the principles of the invention are also suitable for use in fields outside surgery and medicine in general. Such fields may include but are not limited to carpentry, joinery and metal fabrication.

It is to be understood that various modifications, additions and/or alterations may be made to the parts previously described without departing from the ambit of the present invention as defined in the claims appended hereto.

1. A fixation device for fixing a first member in a position relative to a second member, the fixation device comprising:
(a) a shaft having a head and a longitudinal axis;
(b) a first external screw thread on said head;
(c) a first screw portion rotatable about said longitudinal axis;
(d) a first internal screw thread on said first screw portion for engaging said first external screw thread, to facilitate assembly of the fixation device by screwing said first screw portion over said head; and
(e) a second screw portion rotatable about said longitudinal axis independently of said first screw portion;
wherein the first and second screw portions each have an external screw thread having a direction opposite to said first external screw thread on said head, and said external screw thread configured with said first and second screw portions to engage a bore formed in the first and second members thereby fixing the relative position of the first and second members.

2. The fixation device according to claim 1, further comprising a lock nut having a second internal screw thread corresponding with said first external screw thread, and configured to maintain the position of said second screw portion on said shaft.

3. The fixation device according to claim 1, wherein said first external screw thread has a leading end and a trailing end and said trailing end terminates in a flat end to substantially preclude engagement with a threaded member.

4. The fixation device according to claim 1, wherein said first internal screw thread for engaging said first external thread on said head and has a leading end and a trailing end, and said trailing end terminates in a flat end to substantially preclude engagement with a threaded member.

5. The fixation device according to claim 1, wherein said second screw portion is integral with said shaft.

6. A fixation device for fixing a first member in a position relative to a second member, the fixation device comprising:
(a) a shaft having a longitudinal axis and an externally threaded portion;
(b) a head on said shaft;
(c) a first screw portion rotatable about said longitudinal axis;
(d) a second screw portion having a first internal thread corresponding to said externally threaded portion and rotatable about said longitudinal axis independently of said first screw portion; and
(d) a lock nut having a second internal thread corresponding with said externally threaded portion and configured to maintain the position of said second screw portion on said shaft when the fixation device is assembled;
wherein said first and second screw portions each have an external screw thread configured to engage a bore formed in the first and second members thereby fixing the relative position of the members.

7. The fixation device according to claim 6, wherein said first screw portion is a collar screw and assembly of the fixation device comprises passing said shaft through said collar screw prior to threadedly engaging said lock nut and said second screw portion on said shaft.

8. The fixation device according to claim 6, wherein said first screw portion is a collar screw with an opening along its length for receiving a length of said shaft and assembly of the fixation device includes fitting said first screw portion over said shaft.

9. The fixation device according to claim 6, wherein said head has a second external screw thread in a direction opposite to said external screw thread on said first and second screw portions, and wherein said first screw portion has an internal screw thread to facilitate assembly of the fixation device by screwing said first screw portion over said head.

10. A fixation device according to claim 9, wherein said second external screw thread has a leading end and a trailing end, and wherein said trailing end terminates in a flat end to substantially preclude engagement with a threaded member.

11. A fixation device according to claim 9, wherein said internal screw thread on said first screw portion is for engaging said second external screw thread, wherein said internal screw thread has a leading end and a trailing end, and wherein said trailing end terminates in a flat end to substantially preclude engagement with a threaded member.

12. A The fixation device according claim 1, wherein said shaft is flexible.

13. The fixation device according to claim 1, wherein the first and second members are bone.

14. The fixation device according to claim 1, further comprising a retaining screw for engaging said head, thereby retaining the fixation device within said bore, wherein said bore is threaded.

15. A method of fixing a first member in a position relative to a second member, the method including the steps of:
(a) assembling a fixation device, said fixation device comprising:
(i) a shaft with a head and a longitudinal axis;
(ii) an external screw thread on said head;
(iii) a first screw portion rotatable about said longitudinal axis;
(iv) an internal screw thread on said first screw portion for engaging said external screw thread;
(v) a second screw portion rotatable about said longitudinal axis independently of said first screw portion; and
(vi) a first external screw thread on the first screw portion and a second external screw thread on the second screw portions, wherein said first and second external threads are configured in a direction opposite to the direction of said external thread and adapted to engage a threaded bore in the first and second members;
wherein assembly of the fixation device includes screwing said first screw portion over said head;
(b) forming said threaded bore in the first and second members;
(c) introducing the assembled fixation device into said threaded bore;
(d) operating the fixation device so that at least one of said first or second screw portions rotates relative to said threaded bore thereby engaging and positioning the first member relative to the second member, and
(e) locking the fixation device in position.
